(19) United States
(12) Patent Application Publication
(10) Pub. No.: US 2018/0304453 A1
(43) Pub. Date: Oct. 25, 2018

(54) CONTROL METHOD FOR A POWER TOOL

(71) Applicant: Hilti Aktiengesellschaft, Schaan (LI)

(72) Inventors: Roland SCHAER, Grabs (CH); Thomas KINKELDEI, Buchs (CH); Peter HRICKO, Buchs (CH); Manuel GUT, Feldkirch (AT); Michael WIERER, Bludenz (AT)

(73) Assignee: Hilti Aktiengesellschaft, Schaan (LI)

(21) Appl. No.: 15/769,780

(22) PCT Filed: Nov. 15, 2016
(86) PCT No.: PCT/EP2016/077658

§ 371 Date: Apr. 20, 2018

(30) Foreign Application Priority Data
Nov. 17, 2015 (EP) 15194975.7

(51) Int. Cl. B25F 5/00; B25D 11/00

(52) U.S. Cl. CPC B25F 5/001; B25D 11/00; B25D 2250/221; B25D 2250/201; B25D 2211/068

(57) ABSTRACT

A control method for a power tool for rotary tools provides the following: A tool holder is rotated continuously in a forward direction about a working axis by a rotary drive when an operating switch is actuated. The continuous rotation in the forward direction is interrupted by a protective process when a protective device senses blocking of the tool holder. During the protective process, one or more cycles are executed, in which the rotary drive is actuated successively in accordance with an unimpeded rotary movement in a reverse direction and in accordance with an unimpeded rotary movement in the forward direction. The rotary drive is supplied with a first amount of energy for the rotary movement in the reverse direction and with a second amount of energy for the rotary movement in the forward direction. The first amount of energy is smaller than the second amount of energy.

### FIELD OF THE INVENTION

The present invention relates to a power tool for a rotary tool, for example a drill hammer.

EP 2338646 A2 describes a drill hammer having a protective device. The protective device recognizes when the drill hammer begins to slew uncontrollably about its working axis. The reason for the slewing may be a blockage of the drill in a borehole. As a result, the user feels the reactive torque of the motor and can no longer hold the drill hammer. The protective device interrupts the standard continuous rotary motion in the forward direction in order to protect the user from the reactive torque. Instead, the drill hammer periodically changes the rotational direction for as long as the uncontrolled movement of the drill hammer continues and the user keeps the drill hammer in operation. The oscillatory movement of the drill bit may facilitate release of the blockage. The protective device once again enables the standard continuous rotary motion when the blocking of the drill bit is released.

The safety function gives the user the impression that the drill hammer has been switched off. The user then releases the operating switch and switches the drill hammer off. The user subsequently has great difficulty in starting the drill hammer with the blocked drill bit and releasing it from the borehole.

### DISCLOSURE OF THE INVENTION

A control method according to the invention for a power tool for rotary tools provides the following steps. A tool holder is rotated continuously in a forward direction about a working axis by means of a rotary drive when an operating switch is actuated. The continuous rotation in the forward direction is interrupted by a protective process when a protective device detects blocking of the tool holder. During the protective process, one or more cycles are executed, in which the rotary drive is actuated successively according to an unhindered rotary motion in a reverse direction and according to an unhindered rotary motion in the forward direction. The rotary drive is supplied with a first amount of energy for the rotary motion in the reverse direction, and with a second amount of energy for the rotary motion in the forward direction. The first amount of energy is smaller than the second amount of energy.

The attempted deflection in the reverse direction is less than the attempted deflection in the forward direction. On average, the user must brace against a reactive torque of the power tool in a rotational direction that is different from what the user is accustomed to. It is recognizable to the user that the power tool is in operation.

The first amount of energy may be provided by a first current pulse 11 having a first amplitude and a first duration dt2. Analogously, the second amount of energy may be provided with a second current pulse having a second amplitude and a second duration dt2. The first product of the first duration dt2 and the first amplitude is less than the second product of the second duration dt2 and the second amplitude. The current I1 is a suitable form for controlling the amount of energy that is supplied.

A difference between the first amount of energy and the second amount of energy may be increased in successive cycles. In particular, the difference may be increased when the tool holder begins to rotate.

During the protective function, the protective device may monitor a rotational speed, deactivate the protective function in response to an exceedance of a threshold value by the rotational speed, and continue the continuous rotation in the forward direction. When the blockage of the tool holder diminishes, the tool holder on average begins to rotate in the forward direction. The rotational speed is a measure of the diminishing blockage. The threshold value is appropriately selected for a rotational speed for a noncritical blockage.

### BRIEF DESCRIPTION OF THE FIGURES

The following description explains the invention with reference to exemplary embodiments and figures. In the figures:

FIG. 1 shows a drill hammer;

FIG. 2 shows an actuation profile for an oscillatory operation; and

FIG. 3 shows an actuation profile for an oscillatory operation.

Unless stated otherwise, identical or functionally equivalent elements are indicated by the same reference numerals in the figures.

### EMBODIMENTS OF THE INVENTION

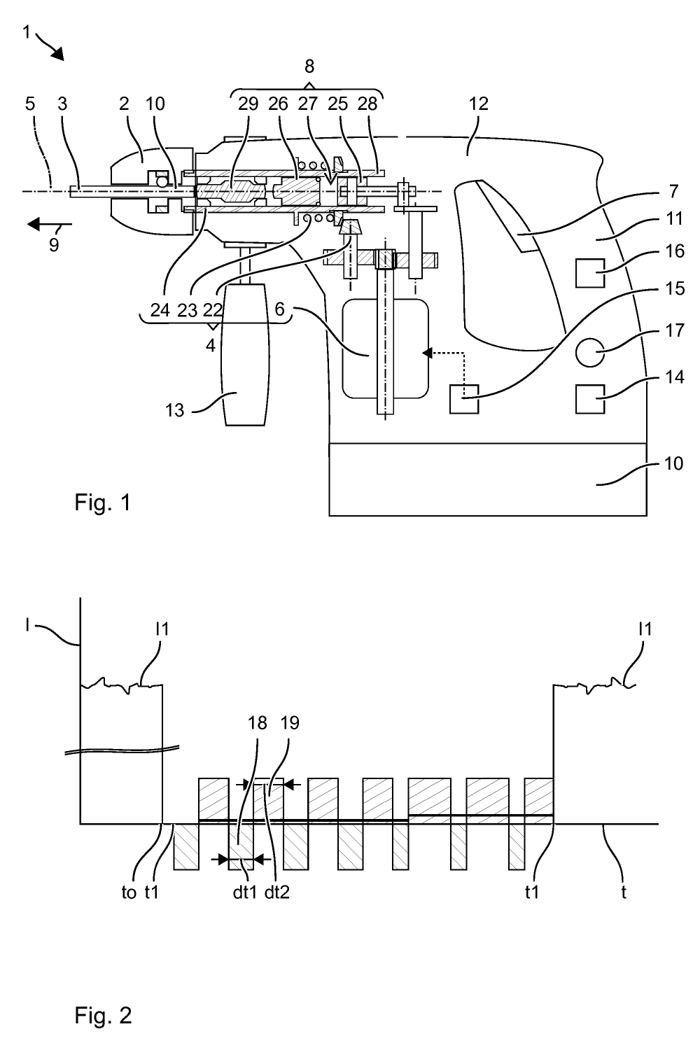

FIG. 1 schematically shows a drill hammer 1 as an example of a hand-held power tool. The drill hammer 1 has a tool holder 2 in which a drill bit 3 or some other tool may be inserted and locked. The drill hammer 1 by way of example has a rotary drive 4 that rotationally drives the tool holder 2 about its working axis 5. The rotary drive 4 is based on an electric motor 6 which the user may switch on and off via an operating switch 7. An additional striking mechanism 8 may periodically strike the drill bit 3 in a striking direction 9 along the working axis 5. The striking mechanism 8 is preferably driven by the same electric motor 6. A power supply may be provided via a battery 10 or a power cable.

The drill hammer 1 has a handle 11 which typically is fastened to an end of a machine housing 12 of the drill hammer 1 facing away from the tool holder 2. An additional handle 13 may be fastened near the tool holder 2, for example. The user may guide and hold the drill hammer 1 by the handle during the drilling. In response to actuating the operating switch 7, the rotary drive 4 rotates continuously in a forward direction, typically in clockwise rotation. The clockwise rotational direction has become established as the standard for drilling and for setting screws. The rotational speed may be regulated to a setpoint value. During the drilling, a small reactive torque resulting from the resistance of rock to the rotating drill bit 3 typically acts on the user. The user may apply the necessary holding force with little effort or exertion.

The drill bit 3 may become blocked in the borehole, resulting in the rotary drive 4, which continues to rotate, exerting a high torque on the tool holder 2. The reactive torque may increase in a jerking manner, which may injure the user and damage the drill hammer 1. To prevent injury to the user and damage to the drill hammer 1, a protective device 14 automatically interrupts the standard operation of the drill hammer 1.

In the event of a malfunction, the protective device 14 initiates an oscillating operation of the rotary drive 4, during which the rotary drive 4 cyclically alternates between a rotation in the reverse direction, typically counterclockwise, and a rotation in the forward direction. The rotary drive 4 rotates somewhat more powerfully in the forward direction than in the reverse direction. This leads to a resultant average rotary motion in the forward direction. If the drill bit 3 releases during the oscillating operation, the protective device 14 ends the oscillating operation and the drill hammer 1 resumes standard operation with a continuous rotary motion in the forward direction.

The user may switch the rotary drive 4 on an off via the operating switch 7. The operating switch 7 by way of example has a deactivating switch position and one or more multiple activating switch positions. The operating switch 7 is preferably monostable in the deactivating switch position. The user must keep the operating switch 7 held down; otherwise, the rotary drive 4 is switched off. The user may select one of the activating switch positions, for example by selecting the user's actuating force. The various switch positions may be associated with different rotational speeds of the rotary drive 4.

A motor controller 15 is activated upon actuation of the operating switch 7. The motor controller 15 monitors the rotational direction of the electric motor 6. The motor controller 15 feeds a current in phase into the windings of the electric motor 6, corresponding to the forward direction. For a drill hammer 1, the forward direction is unchangeably specified as clockwise. For an electric screwdriver, the forward direction for the operation is typically settable by a selector switch 16.

The motor controller 15 monitors the rotational speed of the electric motor 6. The motor controller 15 controls the power consumption of the electric motor 6 to a setpoint value, resulting in a rotational speed that is specified by the load. The motor controller 15, for example, specifies an average current by means of a pulse width modulation. The motor controller 15 may adapt the power consumption in such a way that a constant rotational speed results. The limiting of the power consumption or the rotational speed may be specified, for example, by the user and the intensity of actuation of the operating switch 7.

The electric motor 6 may be a universal motor, a mechanically commutated electric motor 6, or an electrically commutated electric motor 6. The motor controller 15 decouples the electric motor 6 from the power supply when the operating switch 7 is in the deactivating position.

The protective device 14 by way of example contains a motion sensor 17. The motion sensor 17 is situated at or near the handle 13, for example. The motion sensor 17 detects a rotary motion of the handle 13 about the working axis 5. An example of a motion sensor 17 is a gyro sensor which directly determines an angular velocity based on a Coriolis force exerted by the rotary motion. The gyro sensor may contain an oscillating plate, for example, whose oscillation frequency is altered by the Coriolis force. An alternative motion sensor 17 detects an acceleration at two different locations in the drill hammer 1, and from the difference determines the rotary motion of the drill hammer 1.

The protective device 14 evaluates the rotary motion for whether an uncontrolled rotary motion of the drill hammer 1 about the working axis 5 or a slewing of the drill hammer 1 about the working axis 5, caused by the user, is present, which indicates an excessive torque on the tool holder 2. For this purpose an algorithm evaluates, for example, an angular velocity about the working axis 5. The algorithm may recognize the uncontrolled rotary motion according to one or more criteria. One example of a criterion is when the angular velocity exceeds a threshold value that is not exceeded in typical use. Another criterion is when a predefined rotational angle is exceeded within a predefined time period, for example because the drill hammer 1 continues to rotate against the holding force of the user. The criteria may encompass various pairings of angular velocity and rotational angle with suitable threshold values and observation time periods.

The protective device 14 may contain a current sensor. The current sensor monitors the power consumption of the electric motor 6. If the power consumption, in particular the current, exceeds a threshold value, this indicates a malfunction with excessive torque on the tool holder 2.

The protective device 14 triggers a protective measure as soon as the protective device 14 presumes a malfunction. The protective measure initiates a deceleration of the electric motor 6. The electric motor 6 is decelerated to a standstill. The motor controller 15 is provided with appropriate functioning and wiring. For example, the motor controller 15 may short-circuit the windings of the electric motor 6 across a low load resistance. The eddy currents running in the short-circuited windings create a magnetic field that repels the magnetic fields of the permanent magnets, thus decelerating the rotor. Alternatively, the motor controller 15 may energize the electric motor 6 in a way that corresponds to the reverse direction, until the electric motor 6 is decelerated. In addition, a mechanical brake may assist with stopping the rotary drive 4. The stopping of the rotary motion takes place as quickly as possible in order to protect the user.

After the protective device 14 has stopped the rotary drive 4, the protective device 14 initiates a protective process with an oscillatory operation. The protective device 14 causes the motor controller 15 to cyclically alternate the rotational direction between the forward direction and the reverse direction. The protective device 14 initially ignores whether the electric motor 6 is able to carry out a corresponding rotary motion. The actual rotary motion may still be hampered by the blockage of the drill bit 3.

The behavior of the protective device 14 is explained, using a mechanically commutated electric motor 6 as an example (FIG. 2). The electric motor 6 is controlled via the fed current I. The power consumption of the electric motor 6 is limited via the provided current I. The voltage is assumed to be constant. A change in the algebraic sign of the current I results in a change in the rotational direction of the electric motor 6. For electrically commutated electric motors, the control method may be transferred to the switching frequencies in a customary manner.

The motor controller 15 feeds a current I1 for the forward direction during normal operation. The protective device recognizes a malfunction at time to. The motor controller 15 ends the feeding of the current I. The electric motor 6 is decelerated to a standstill up to time t1. The protective device 14 begins the oscillatory operation. The motor controller 15 feeds a first current pulse 18 and a second current pulse 19 in alternation. The first current pulse has the opposite algebraic sign from the current I1. The first current pulse 18 accordingly brings about a torque of the electric motor 6 in the reverse direction. The tool holder 2 rotates about a first angle in the reverse direction, depending on the blockage. The second current pulse 19 has the same algebraic sign as the current I1, and accordingly brings about a torque in the specified rotational direction. The tool holder 2 rotates about a second angle in the forward direction, depending on the blockage. If the blockage is equal in both rotational directions, the tool holder 2 moves slowly in the forward direction. The cycle made up of the first current pulse 18 and the second current pulse 19 is repeated multiple times.

The protective device 14 has a different actuation profile for the forward direction and for the reverse direction. The amplitude of the current pulses 18, 19 is the same. The motor controller 15 limits the power consumption of the electric motor 6 to the same value in both the forward direction and the reverse direction. However, a duration dt1 of the first current pulse 18 is shorter than the duration dt2 of the second current pulse 19. The electric motor 6 is thus provided with less energy for the movement in the reverse direction than energy for the forward direction. By way of example, the first duration is 22 ms and the second duration dt2 is 28 ms. Averaged over the cycle, this results in an average torque in the specified rotational direction. In the event of a blocked drill bit 3, the user feels an average resultant torque in the same rotational direction as usually occurs during drilling. The first duration dt1 is in the range between 75% and 95%, at most 90%, for example, of the second duration dt2.

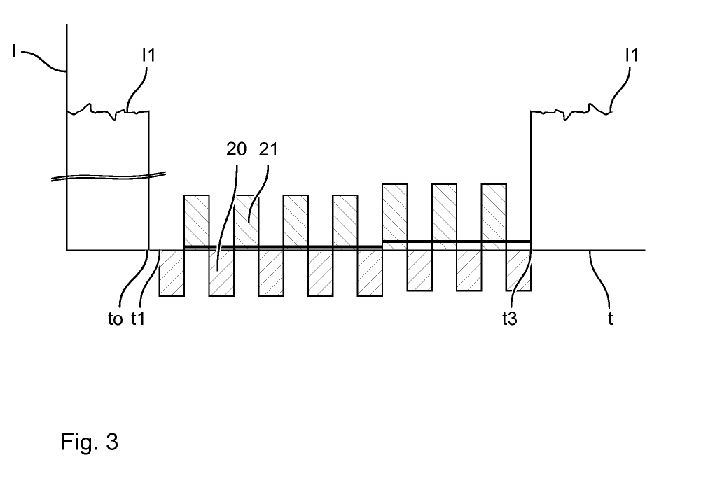

In a second example, the amplitude of a first current pulse 20 for a torque in the reverse direction is less than the amplitude of a second current pulse 21 for a torque in the forward direction (FIG. 3). The cycle made up of the first current pulses 20 and second current pulses 21 is repeated multiple times. The torque in the reverse direction is in the range between 75% and 95% of the torque in the forward direction. The two examples may be combined. Lastly, in each of the cycles, the energy provided for the reverse direction, i.e., the product of the duration and the power, is less than the energy provided for the forward direction.

The drill bit 3 may be partially or completely released from the blockage. Due to the moderately powerful forward movement of the oscillatory operation instead of reverse movement, the rotary drive 4 begins to rotate in the clockwise direction. When the protective device detects that the rotational speed averaged over one or more cycles exceeds a threshold value, for example 100 rpm, the protective device 14 increases the proportion of the movement in the forward direction in the oscillatory operation. In the first example above, the first duration dt1 for the reverse direction is shortened to 20 ms and the second duration dt2 for the forward direction is increased by 30 ms (FIG. 2). In the second example above, the power consumption is decreased for the reverse direction and increased for the forward direction (FIG. 3). The rotary drive 4 should then rotate slightly more quickly to the right, provided that the blockage is overcome. The protective device 14 may check whether a corresponding increase in the angular velocity results. The proportion for the forward direction may be increased in multiple steps.

The protective device 14 ends the protective function when a rotational speed of the tool holder 2 exceeds a threshold value. The threshold value is 2000 rpm, for example. When the tool holder 2 reaches this rotational speed during the oscillatory operation, a diminishing or negligible blockage is assumed. For example, the rotational speed reaches the threshold value at time t3. The power consumption of the electric motor 6 once again conforms to the specifications by the user or the standard setting of the drill hammer 1, the same as prior to activation of the protective function.

The protective device 14 monitors the rotary motion of the electric motor 6 or some other component of the rotary drive 4. For a complete blockage, the rotational speed in the predefined rotational direction is zero. If the rotational speed is below a small threshold value, for example 10 revolutions per minute (rpm), for a predefined duration, for example 5 seconds, the protective device 14 deactivates the drill hammer 1. The motor controller 15 interrupts the power supply to the electric motor 6.

The preceding description assumes a clockwise rotation as a standard forward direction, and a counterclockwise rotation as a reverse direction. The hand-held power tool may also have a counterclockwise rotation as a standard forward direction, or, as is common in electric screwdrivers, may have a settable forward direction, in which case the rotational directions in the above description should be correspondingly interchanged.

The rotary drive 4 contains the electric motor 6. The electric motor 6 is coupled to the tool holder 2 via a drive train. The drive train has a reduction gear 22, for example. In addition, a friction clutch 23 may be provided. A shaft 24, for example a hollow shaft, couples the rotary drive 4 to the tool holder 2.

The striking mechanism 8 is a pneumatic striking mechanism, for example. An exciter piston 25 is forced by the electric motor 6 into a periodic forward and backward movement along the working axis 5. A striker 26 that runs on the working axis 5 is coupled to the exciter piston 25 via a pneumatic spring. The pneumatic spring is formed by a pneumatic chamber 27 that is closed off by the exciter piston 25 and the striker 26. The exciter piston 25 and the striker 26 may be guided in a guide tube 28 which at the same time closes off the pneumatic chamber 27 in the radial direction. A plunger 29 may be situated from the striker 26 in the striking direction 9. The striker 26 strikes the plunger 29, which transmits the impact to the drill bit 3 situated in the tool holder 2.

1. A control method for a power tool for rotary tools, comprising:
continuously rotating a tool holder in a forward direction about a working axis by a rotary drive in response to an actuation of an operating switch;
interrupting the continuous rotation in the forward direction by a protective process when a protective device detects blocking of the tool holder,
wherein the protective process comprises executing one or more cycles in which the rotary drive is actuated successively according to a rotary motion in a reverse direction and according to a rotary motion in the forward direction; and,
supplying the rotary drive with a first amount of energy for the rotary motion in the reverse direction, and with a second amount of energy for the rotary motion in the forward direction, wherein the first amount of energy is smaller than the second amount of energy.

2. The control method according to claim 1, wherein the first amount of energy is between 75% and 95% of the second amount of energy.

3. The control method according to claim 1, wherein, during the protective process, a motor controller feeds into the electric motor a first current pulse for the first amount of energy and feeds a second current pulse for the second amount of energy in one cycle, wherein a duration of the first current pulse is shorter than a duration of the second current pulse.

4. The control method according to claim 1, wherein, during the protective process, a motor controller feeds into the electric motor a first current pulse for the first amount of energy and feeds a second current pulse for the second amount of energy in one cycle, wherein an amplitude of the first current pulse is less than an amplitude of the second current pulse.

5. The control method according to claim 1, wherein a difference between the first amount of energy and the second amount of energy is increased stepwise in successive cycles.

6. The control method according to claim 1, wherein during the protective process, the protective device monitors a rotational speed, deactivates the protective process in response to an exceedance of a threshold value by the rotational speed, and continues the continuous rotation in the forward direction.

7. The control method according to claim 2, wherein, during the protective process, a motor controller feeds into the electric motor a first current pulse for the first amount of energy and feeds a second current pulse for the second amount of energy in one cycle, wherein a duration (dt1) of the first current pulse is shorter than a duration (dt2) of the second current pulse.

8. The control method according to claim 2, wherein, during the protective process, a motor controller feeds into the electric motor a first current pulse for the first amount of energy and feeds a second current pulse for the second amount of energy in one cycle, wherein an amplitude of the first current pulse is less than an amplitude of the second current pulse.

9. The control method according to claim 2, wherein a difference between the first amount of energy and the second amount of energy is increased stepwise in successive cycles.

10. The control method according to claim 3, wherein a difference between the first amount of energy and the second amount of energy is increased stepwise in successive cycles.

11. The control method according to claim 4, wherein a difference between the first amount of energy and the second amount of energy is increased stepwise in successive cycles.

12. The control method according to claim 2, wherein during the protective process, the protective device monitors a rotational speed, deactivates the protective process in response to an exceedance of a threshold value by the rotational speed, and continues the continuous rotation in the forward direction.

13. The control method according to claim 3, wherein during the protective process, the protective device monitors a rotational speed, deactivates the protective process in response to an exceedance of a threshold value by the rotational speed, and continues the continuous rotation in the forward direction.

14. The control method according to claim 4, wherein during the protective process, the protective device monitors a rotational speed, deactivates the protective process in response to an exceedance of a threshold value by the rotational speed, and continues the continuous rotation in the forward direction.

15. The control method according to claim 5, wherein during the protective process, the protective device monitors a rotational speed, deactivates the protective process in response to an exceedance of a threshold value by the rotational speed, and continues the continuous rotation in the forward direction.

16. The control method according to claim 7, wherein during the protective process, the protective device monitors a rotational speed, deactivates the protective process in response to an exceedance of a threshold value by the rotational speed, and continues the continuous rotation in the forward direction.

17. The control method according to claim 8, wherein during the protective process, the protective device monitors a rotational speed, deactivates the protective process in response to an exceedance of a threshold value by the rotational speed, and continues the continuous rotation in the forward direction.

18. The control method according to claim 7, wherein a difference between the first amount of energy and the second amount of energy is increased stepwise in successive cycles.

19. The control method according to claim 8, wherein a difference between the first amount of energy and the second amount of energy is increased stepwise in successive cycles.

20. The control method according to claim 18, wherein during the protective process, the protective device monitors a rotational speed, deactivates the protective process in response to an exceedance of a threshold value by the rotational speed, and continues the continuous rotation in the forward direction.
